(19) United States
(12) Patent Application Publication
(10) Pub. No.: US 2019/0333067 A1
(43) Pub. Date: Oct. 31, 2019

(54) DISAGGREGATED HARDWARE PLATFORMS FOR JOINT TRANSACTION PROCESSING

(71) Applicants: Andrew David Monaghan, Dundee (GB); Robin Ian Gregor Angus, Fife (GB)

(72) Inventors: Andrew David Monaghan, Dundee (GB); Robin Ian Gregor Angus, Fife (GB)

(21) Appl. No.: 15/964,231

(22) Filed: Apr. 27, 2018

(51) Int. Cl. G06Q 20/40; G06Q 20/38; G06Q 20/32; G06Q 20/34

(52) U.S. Cl. CPC G06Q 20/4012; G06Q 20/34; G06Q 20/32; G06Q 20/3829

(57) ABSTRACT

Various embodiments each include at least one of systems, terminals, methods, and software for disaggregated hardware platforms for joint transaction processing and fulfillment. Such embodiments enrich the transaction authorization process to capture and encrypt the authentication details at one device to transport the encrypted data to another device for fulfilment. One embodiment includes storing transaction data, received from a first terminal via a network, including a customer identifier, personal identifying data encrypted with an encryption key of the first terminal, a terminal identifier of the first terminal, and data defining at least one transaction activity input at the first terminal. The method further includes transmitting the stored transaction data to a second terminal in response to a received request therefrom. The second terminal may then submit a portion of the transaction and additional data to an authorization process to obtain approval for fulfillment of the transaction by the second terminal.

### BACKGROUND INFORMATION

Bank branch transformation is changing the physical make up of self-service and assisted-service devices as well as locations where multiple automated teller machines (ATMs) are deployed. Transaction authorization systems have to date assumed that a transaction will be authorized and fulfilled via the same device. This assumption prevents hardware disaggregation where a transaction may be initiated on one device or terminal and fulfilled or otherwise completed at another.

### SUMMARY

Various embodiments herein each include at least one of systems, terminals, methods, and software for disaggregated hardware platforms for joint transaction processing and fulfillment. Such embodiments enrich the transaction authorization process to capture and encrypt the authentication details at one device to transport the encrypted data to another device for fulfilment.

One method embodiment includes storing transaction data received from a first terminal via a network. The transaction data in such embodiments may include a customer identifier, personal identifying data encrypted with an encryption key of the first terminal, a terminal identifier of the first terminal, and data defining at least one transaction activity input at the first terminal. The method further includes transmitting the stored transaction data to a second terminal in response to a received request from the second terminal. In such embodiments, the second terminal is to submit, over the network, at least a portion of the transaction data and additional data to a transaction authorization process to obtain approval or denial for fulfillment of a transaction in accordance therewith by the second terminal.

Another method embodiment includes receiving customer identifying and authentication input at a transaction fulfillment terminal and retrieving, via a network, transaction data based on at least the customer identifying input from a transaction staging service. The transaction data may include a customer identifier, personal identifying data encrypted with an encryption key of a terminal utilized to stage the transaction data, a terminal identifier of the terminal utilized to stage the transaction data, and data defining at least one transaction activity to be performed. This method then submits a transaction request based on the retrieved transaction data from the transaction fulfillment terminal via the network to a transaction processor and the transaction fulfillment terminal then receives transaction fulfillment data including a command to perform the at least one transaction activity in response to the submitted transaction fulfillment request. The method then performs the at least one transaction activity by the transaction fulfillment terminal according to the transaction fulfillment data.

A system according to some embodiments includes a network interface device, a computer processor, and a memory device storing instructions executable by the processor to perform data processing activities. The data processing activities may include activities according to the methods above.

### BRIEF DESCRIPTION OF THE DRAWINGS

FIG. 1 is a logical block diagram of a networked system, according to an example embodiment.

FIG. 2 is a block flow diagram of a method, according to an example embodiment.

FIG. 3 is a block flow diagram of a method, according to an example embodiment.

FIG. 4 is a block diagram of a computing device, according to an example embodiment.

### DETAILED DESCRIPTION

Various embodiments herein each include at least one of systems, terminals, methods, and software for disaggregated hardware platforms for joint transaction processing and fulfillment. Such embodiments enrich the transaction authorization process to capture and encrypt the authentication details at one device to transport the encrypted data to another device for fulfilment.

The various embodiments include and allow for independent collection of transaction authorization data for the fulfilment of a transaction allowing multiple devices to participate in the process of a transaction. At the same time, this the various embodiments minimize the impact to existing transaction authorization systems and processes by remaining compatible with most existing systems, processes, and protocols. An example of such a system may be an automated teller machine lobby. There may be, for example, two or more kiosks on which customers may start transactions and one or more fulfillment terminal where transactions are completed. Customers may begin at a kiosk by identifying themselves with their bank cards, mobile devices, or input account or identity information and also provide authentication input such as Personal Identification Numbers (PINs), biometric inputs, and the like. On the kiosks, customers define transactions such as withdrawals, deposits, purchases of valuable media such as postage stamps, parking vouchers, travel and admission tickets, and the like. Once the transactions have been defined, the user may close the session at the kiosk, the kiosk stores data of the defined transaction with a network service, and the customer may proceed to a fulfillment terminal to complete the transaction. The user may again identify themselves on the fulfillment device in the same manner as on the kiosk, provide a ticket with a code as may be provided by the kiosk, or other identification and authentication method. Once identified and authenticated, the fulfillment terminal retrieves the defined transaction from the network service, submits the transaction to a transaction processing service, and, when approved, completes the transaction by performing one or more activities of the transaction such as dispensing currency, dispensing valuable media, and receiving a deposit.

These and other embodiments are described herein with reference to the figures.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

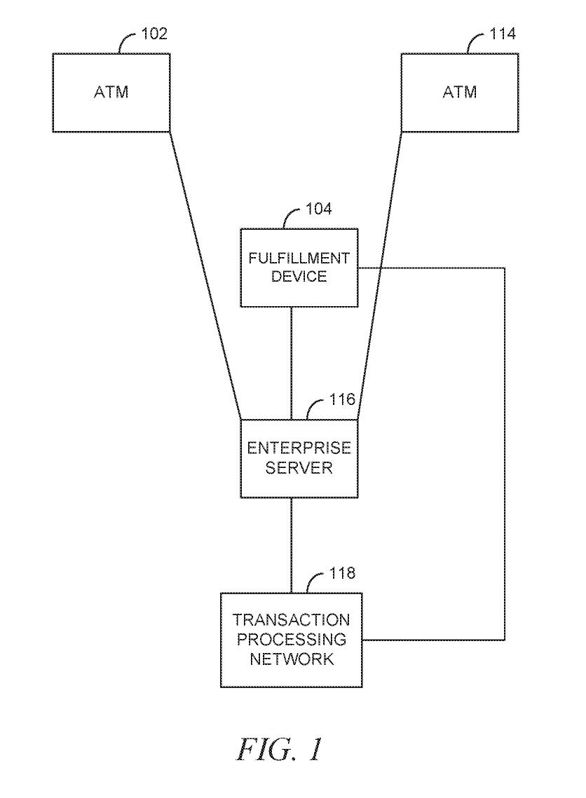

FIG. 1 is a logical block diagram of a networked system 100, according to an example embodiment. The networked system 100 is an example of the four tiers of typical embodiments. The three tiers include as a first-tier software on a self-service or assisted-service device, such as an ATM 102, 114 or a self-service checkout terminal, that is used to prepare the transaction, including encrypting PIN data to remain compliant with industry standards and regulatory compliant in some jurisdictions. A second-tier is a cloud or enterprise system 116 that allows the prepared transaction to be temporarily stored, or staged, prior to fulfilment. The staged transaction includes the PIN data and an identifier of the terminal (i.e., first tier device) on which the transaction was input. This keeps the PIN data secure while also providing the terminal identifier (TID) that can be used to identify a proper encryption key of the device used to prepare the transaction to decrypt the encrypted PIN data. The TID of the terminal used to prepare and stage the transaction is referred to as the preparing device identifier (PDID). The third-tier is software on a self-service or assisted-service device 104 that fulfills the pending, staged transaction. The fulfillment device 104 retrieves the staged transaction from the enterprise system 116 and submits the transaction to the fourth tier, which is a transaction processing network 118 that handles the banking and transaction approval/denial part of the transaction and returns commands and other data to the fulfillment device 104 to perform transaction fulfillment activities, such as dispensing currency and valuable media and receiving a deposit. Utilizing an enriched transaction authorization message that specifies a TID of the fulfillment device 104 on which the third-tier software executes and the PDID, the transaction processing network 118 is able to identify and record the ATM 102, 114 on which the transaction was defined and a PIN decryption key and also identify the fulfillment device 104 on which the transaction was fulfilled.

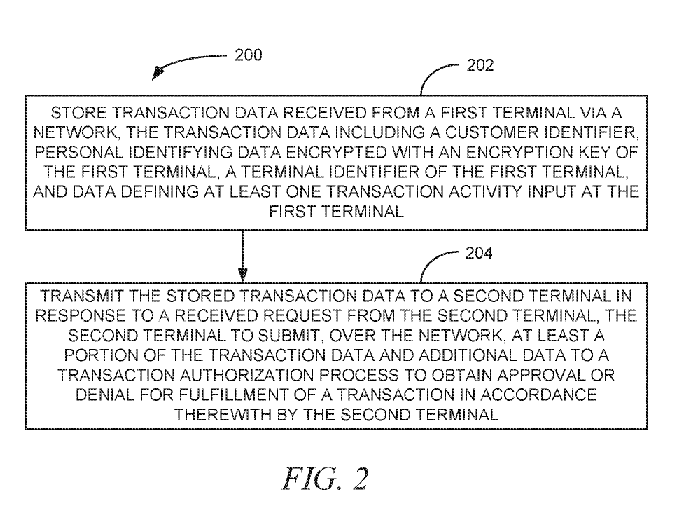

FIG. 2 is a block flow diagram of a method 200, according to an example embodiment. The method 200 is an example of a method that may be performed on a server to receive data of transactions defined on one terminal, store/stage defined transactions, and then provide data of the defined transactions to fulfillment terminals. The method 200 is a method that may be performed on an enterprise server 116 of the second-tier in FIG. 1.

The method 200 includes storing 202 transaction data received from a first terminal via a network. The stored 202 transaction data, in some embodiments, includes a customer identifier, personal identifying data encrypted with an encryption key of the first terminal, a terminal identifier of the first terminal (e.g., a PDID), and data defining at least one transaction activity input at the first terminal. The method 200 further includes transmitting 204 the stored 202 transaction data to a second terminal in response to a received request from the second terminal. In such embodiments, the second terminal is to submit, over the network, at least a portion of the transaction data and additional data to a transaction authorization process to obtain approval or denial for fulfillment of a transaction in accordance therewith by the second terminal.

In some embodiments, the data defining the at least one transaction activity includes, for each transaction activity, a transaction type and a transaction amount. For example, the data for one transaction activity may provide “WITHDRAWAL, $200.”

In some embodiments of the method 200, the received transaction data is a transaction authorization request, such as for a withdrawal, a deposit, or a purchase. In another embodiment, the portion of the transaction data transmitted to the transaction authorization process includes the encrypted personal identifying data (e.g., an encrypted PIN) and the terminal identifier of the first terminal to identify the first terminal to the authorization process to select an appropriate decryption key to decrypt the encrypted personal identifying data.

In some embodiments, the customer identifier is at least one data item associated with an account holder of an account against which the transaction is to be performed. For example, the data item may be a data item encoded in a magnetic strip or radio frequency or contact chip of a customer card, a mobile wallet identifier, a biometric identifier, and the like

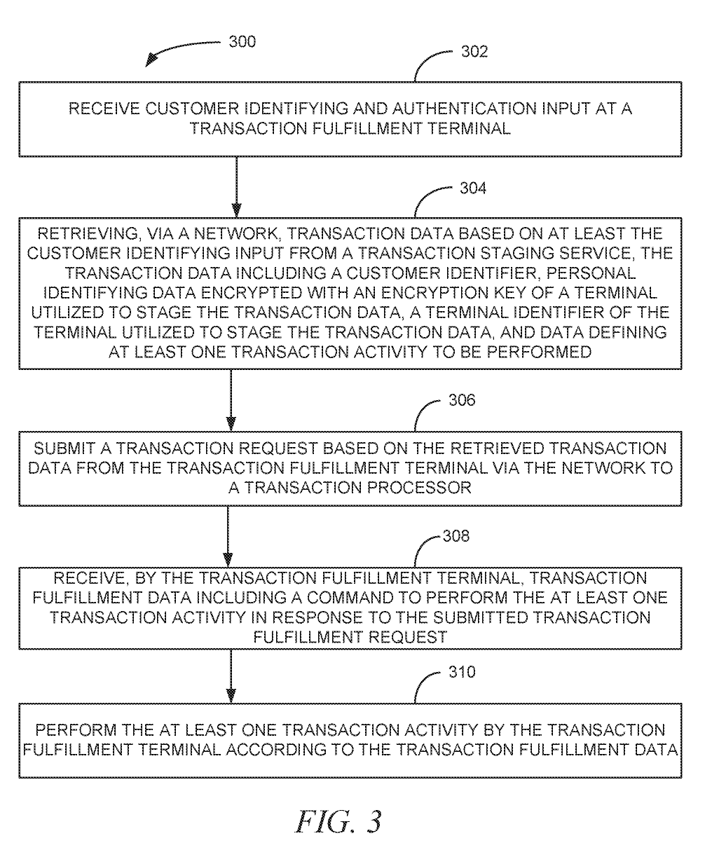

FIG. 3 is a block flow diagram of a method 300, according to an example embodiment. The method 300 is an example of a method performed by a fulfillment device, such as fulfillment device 114 of FIG. 1. Note that a fulfillment device may include various devices and capabilities, such as abilities to receive payments and deposits and to dispense currency and other valuable media including printed valuable media.

The method 300 includes receiving 302 customer identifying and authentication input at a transaction fulfillment terminal and retrieving 304, via a network, transaction data based on at least the customer identifying input from a transaction staging service. In some embodiments, the transaction data includes a customer identifier, personal identifying data encrypted with an encryption key of a terminal utilized to stage the transaction data, a terminal identifier of the terminal utilized to stage the transaction data, and data defining at least one transaction activity to be performed. The method 300 further includes submitting 306 a transaction request based on the retrieved transaction data from the transaction fulfillment terminal via the network to a transaction processor and subsequently receiving 308 transaction fulfillment data including a command to perform the at least one transaction activity in response to the submitted 306 request. The method 300 then performs 310 the at least one transaction activity by the transaction fulfillment terminal according to the transaction fulfillment data.

In some embodiments of the method 300, the transaction staging service receives transaction data from the terminal utilized to stage the transaction data. In such embodiments, the method 300 with regard to the transaction staging service further stores transaction data received from the terminal utilized to stage the transaction data via the network. The received transaction data in such embodiments includes the customer identifier, the personal identifying data encrypted with the encryption key of the terminal utilized to stage the transaction data, the terminal identifier of the terminal utilized to stage the transaction data, and data defining the at least one transaction activity input at the first terminal.

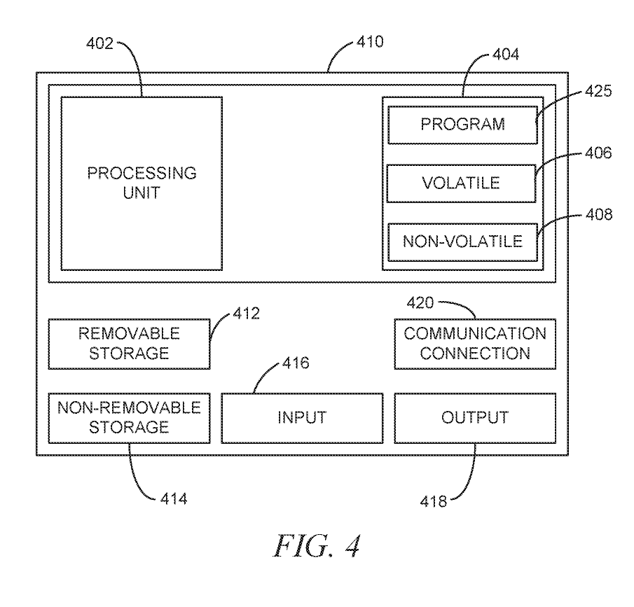

FIG. 4 is a block diagram of a computing device, according to an example embodiment. In one embodiment, multiple such computer systems are utilized in a distributed network to implement multiple components in a transaction-based environment. An object-oriented, service-oriented, or other architecture may be used to implement such functions and communicate between the multiple systems and components. One example computing device in the form of a computer 410, may include a processing unit 402, memory 404, removable storage 412, and non-removable storage 414. Memory 404 may include volatile memory 406 and non-volatile memory 408, Computer 410 may include—or have access to a computing environment that includes—a variety of computer-readable media, such as volatile memory 406 and non-volatile memory 408, removable storage 412 and non-removable storage 414. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 410 may include or have access to a computing environment that includes input 416, output 418, and a communication connection 420. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 402 of the computer 410. A hard drive, CD-ROM, and RAM are some examples of articles including a non-transitory computer-readable medium. For example, the computer program 425 may be a program executable to perform one or more of the methods, or portions thereof, as illustrated and described herein.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims,

What is claimed is:

1. A method comprising:
storing transaction data received from a first terminal via a network, the transaction data including a customer identifier, personal identifying data encrypted with an encryption key of the first terminal, a terminal identifier of the first terminal, and data defining at least one transaction activity input at the first terminal;
transmitting the stored transaction data to a second terminal in response to a received request from the second terminal, the second terminal to submit, over the network, at least a portion of the transaction data and additional data to a transaction authorization process to obtain approval or denial for fulfillment of a transaction in accordance therewith by the second terminal.

2. The method of claim 1, wherein the data defining the at least one transaction activity includes, for each transaction activity, a transaction type and a transaction amount.

3. The method of claim 1, wherein the received transaction data is a transaction authorization request.

4. The method of claim 1, wherein the portion of the transaction data transmitted to the transaction authorization process includes the encrypted personal identifying data and the terminal identifier of the first terminal to identify the first terminal to the authorization process to select an appropriate decryption key to decrypt the encrypted personal identifying data.

5. The method of claim 1, wherein the personal identifying data is a Personal Identification Number (PIN).

6. The method of claim 1, wherein the additional data submitted by the second terminal to the transaction authorization process incudes a terminal identifier of the second terminal.

7. The method of claim 1, wherein the customer identifier is at least one data item associated with an account holder of an account against which the transaction is to be performed.

8. The method of claim 7, wherein the data item of the customer identifier is one of data read from a card by a card reading device of the first terminal and a data item received wirelessly by a wireless communication device of the first terminal.

9. A method comprising:
receiving customer identifying and authentication input at a transaction fulfillment terminal;
retrieving, via a network, transaction data based on at least the customer identifying input from a transaction staging service, the transaction data including a customer identifier, personal identifying data encrypted with an encryption key of a terminal utilized to stage the transaction data, a terminal identifier of the terminal utilized to stage the transaction data, and data defining at least one transaction activity to be performed;
submitting a transaction request based on the retrieved transaction data from the transaction fulfillment terminal via the network to a transaction processor;
receiving, by the transaction fulfillment terminal, transaction fulfillment data including a command to perform the at least one transaction activity in response to the submitted transaction fulfillment request; and
performing the at least one transaction activity by the transaction fulfillment terminal according to the transaction fulfillment data.

10. The method of claim 9, wherein a terminal identifier of the fulfillment terminal is included when submitting the transaction request to the transaction processor.

11. The method of claim 9, wherein the transaction staging service receives transaction data from the terminal utilized to stage the transaction data, the method with regard to the transaction staging service further comprising:
storing transaction data received from the terminal utilized to stage the transaction data via the network, the received transaction data including the customer identifier, the personal identifying data encrypted with the encryption key of the terminal utilized to stage the transaction data, the terminal identifier of the terminal utilized to stage the transaction data, and data defining the at least one transaction activity input at the first terminal.

12. The method of claim 11, wherein the personal identifying data is a Personal Identification Number (PIN).

13. The method of claim 9, wherein the data defining the at least one transaction activity includes, for each transaction activity, a transaction type and a transaction amount.

14. The method of claim 9, wherein the command to perform at least one transaction activity includes a command to dispense an amount of currency.

15. The method of claim 9, wherein the customer identifying input is at least one data item associated with an account holder of an account against which the transaction is to be performed.

16. The method of claim 15, wherein the data item of the customer identifying input is one of data read from a card by a card reading device of the first terminal and a data item received wirelessly by a wireless communication device of the first terminal.

17. A system comprising:
a network interface device;
a computer processor;
a memory device storing instructions executable by the processor to perform data processing activities comprising:
storing, on the memory device, transaction data from a first terminal via the network interface device, the transaction data including a customer identifier, personal identifying data encrypted with an encryption key of the first terminal, a terminal identifier of the first terminal, and data defining at least one transaction activity input at the first terminal;
transmitting the stored transaction data via the network interface device to a second terminal in response to a received request from the second terminal, the second terminal to submit, over a network, at least a portion of the transaction data and additional data to a transaction authorization process to obtain approval or denial for fulfillment of a transaction in accordance therewith by the second terminal.

18. The system of claim 17, wherein the data defining the at least one transaction activity includes, for each transaction activity, a transaction type and a transaction amount.

19. The system of claim 17, wherein the received transaction data is a transaction authorization request.

20. The system of claim 17, wherein the portion of the transaction data transmitted to the transaction authorization process includes the encrypted personal identifying data and the terminal identifier of the first terminal to identify the first terminal to the authorization process to select an appropriate decryption key to decrypt the encrypted personal identifying data.
